(19) United States
(12) Patent Application Publication
(10) Pub. No.: US 2023/0330465 A1
(43) Pub. Date: Oct. 19, 2023

(54) SYSTEMS AND METHODS FOR AUTOMATIC REMOTE TESTING OF A FIRE SYSTEM PRESSURE SWITCH

(71) Applicant: Potter Electric Signal Company, LLC, Hazelwood, MO (US)

(72) Inventors: Timothy Decker, Florissant, MO (US); Patrick Chisholm, O'Fallon, MO (US); Lucas Hoemann, Washington, MO (US); Mark Hoemann, Washington, MO (US)

(21) Appl. No.: 18/133,928

(22) Filed: Apr. 12, 2023

Related U.S. Application Data
(60) Provisional application No. 63/330,599, filed on Apr. 13, 2022.

(51) Int. Cl. A62C 37/50

(52) U.S. Cl. CPC A62C 37/50

(57) ABSTRACT

Systems and methods for the remote testing of a pressure switch, particularly a supervisory switch in a fire sprinkler system. The systems and methods detected a decrease in pressure below a target low threshold and above a modified high threshold where the modified high threshold is moved during testing to allow for testing without need to increase the pressure in the system substantially above a supervisory pressure.

### CROSS REFERENCE TO RELATED APPLICATION(S)

This application claims the benefit of U.S. Provisional Patent Application 63/330,599 filed Apr. 13, 2022, the entire disclosure of which is herein incorporated by reference.

### BACKGROUND

### 1. Field of the Invention

This disclosure generally relates to testing of supervisory systems that monitor fluid pressure and specifically it relates to testing of supervisory systems that monitor air or liquid pressure in fire sprinkler systems.

### 2. Description of the Related Art

To fight fires in modern buildings, firefighters use a wide variety of tools but are also regularly aided by systems within the building. Modern buildings almost universally include liquid-based fire protection systems to control or extinguish fires. Fire sprinkler systems generally follow a fairly standardized principle. A liquid firefighting material (generally water) is maintained in a series of pipes, generally under pressure, which are arranged throughout all areas of the building.

In a wet pipe system, the liquid firefighting material is actually stored within the pipes, whereas in a dry pipe system, the liquid is stored external to the piping (with water often being stored external to the building (usually by the system simply being connected to a pressurized municipal source)) while the pipes contain pressurized air, nitrogen, or other gas. Attached to these pipes are various sprinkler heads which, when activated, will spray the liquid into a predetermined area. When a fire situation is detected, sprinklers on the pipe structure are activated. This opens them and allows them to spray the liquid firefighting material from the pipe system.

The activation is often performed by a heat sensitive element, an integral part of the sprinkler, which is activated by the heat from the fire. Alternatively, other forms of activation may be used. Specifically, the sprinkler utilizes a “plug” holding it closed. The plug is damaged which results in the pressurized liquid firefighting material (or gas followed by liquid) inside the pipes being pulled to and through the opening in the now activated sprinkler head. Generally, each sprinkler has its “plug” and is activated independent of all other sprinklers. This action dispenses the liquid on the fire and serves to control or extinguish the fire.

This system can be very effective because there is no reliance on notification systems or other separate components where a communication breakdown could occur. There is always concern in a fire protection system, that the fire could damage any form of notification system prior to it being able to provide notice. In the arrangement discussed above, there is very little possibility of the sprinkler system failing to activate due to damage from the fire. As the damage causes the activation, the system simply enters into a spray mode at that sprinkler. Further, the sprinkler will generally spray until the system is shut off as the liquid source is typically municipal water lines providing a steady feed and there is no switch which can serve to re-plug the sprinkler once activated. Instead, the sprinkler must be replaced or the water shut off to the building.

Because of the fact that most fire protection systems utilize some type of sprinkler activated by the presence of fire, heat, smoke, or some other detectable situation near the location of the sprinkler, they generally do not use smoke detectors or other forms of fire detection apparatus to activate the system generally. While this works from a fire fighting perspective, in a large building it is often necessary to notify both occupants of the building that the system has activated, and to notify the fire department that the system has activated so that they can come and fight the fire. Therefore, systems beyond those simply to activate the fire sprinkler are desirable as part of the system.

While some sprinkler systems utilize smoke detectors and other detection mechanisms to provide notification, others do not. Further, even if they include detection apparatus, it can be desirable to know if only smoke has been detected and/or if the sprinkler system has been activated. Further, detection and notification systems can be damaged by the very fire that the sprinkler has reacted to prior to providing notification. Therefore, most sprinkler systems utilize a system to detect that the sprinkler system has activated as an alternative notification system.

While these detection systems can be simple or complex, one system relies on an indication of loss of pressure within the pipes of the sprinkler system to detect that a sprinkler head has activated. In particular, when a sprinkler head (or multiple heads) activate, gas pressure in the pipes will decrease as gas flows out the activated head. This decrease in pressure is what allows the pressure of the liquid source to push liquid into the pipes and eventually out the sprinkler head and is, thus, essential to correct operation of the system. This change in pressure can be detected through the use of a pressure detector or pressure switch which is placed in the piping. It should be recognized that in other systems and specifically in many liquid systems activation is actually detected due to a gain in pressure. Thus, components designed to operate in such systems generally are able to measure and detect a change in pressure, often above or below a specific target amount.

Because loss or gain of gas pressure specifically indicates a sprinkler head activation, or a system failure resulting in pressure loss which could result in liquid dispensing which is another potential emergency, a pressure switch provides excellent notification of potential danger. Because of this, dry pipe sprinkler systems will typically include a system wide gas pressure switch. This is commonly called a supervisory pressure switch. The sensor is typically a switch which will activate when pressure drops below a certain target low threshold value. If the system remains at its expected or “supervisory” pressure, the switch remains deactivated (or switched to a particular detectable “off” position). Activation of the switch will typically serve to trigger an alarm situation.

FIG. 1 provides for a general block diagram of an embodiment of a water flow alarm installation of a dry pipe sprinkler system (100) which utilizes a pressure switch (113). The system (100) includes typical components such as the municipal water source (107) which feeds a valve chamber (105). The valve chamber (105) includes water (151) which is held in place by air or other gas (153) supplied from the air supply subsystem (103). The pressure in the valve chamber (105) also holds shut the valve (155) which would allow water from the water source (107) to enter the riser (109) and connected sprinkler piping.

Attached to the riser (109) is a pressure monitoring subsystem (101). The pressure monitoring subsystem (101) includes piping (121) which is in fluid communication with the riser (109) via the valve (111). This allows for the air pressure supervisory switch (113) to monitor the pressure in the riser (109) as the pressure monitoring subsystem (101) is at the same pressure as the riser (109) so long as valve (111) remains open.

Because the supervisory switch (113) is in fluid communication with the riser (109), the switch (113) detects the pressure of the riser (109) as the piping (121) is at the same pressure. Thus, the switch (113) can detect when the pressure in the riser (109) drops below a target low threshold. The switch (113) can also detect over pressurization of the sprinkler system (100) should the air supply subsystem (103) supply too much gas to the sprinkler system (100) by the pressure going over a target high threshold. While over supply is not as common of a danger scenario as loss of pressure, over filling the system (100) with gas can present a further danger situation because it can damage components or cause elements in the system to rupture or leak. It may also indicate a malfunction in part of the air supply subsystem (103).

As is likely apparent, because the pressure switch (113) is an important notification and safety component of the system (100), it must be regularly tested to make sure it continues to work as intended and will switch (provide notification) when the pressure in the riser (109) is too low (indicating a leak or sprinkler activation) or too high (indicating overfill with gas). Traditionally, this testing was performed manually where a portion of the piping (121) in the pressure monitoring subsystem (101) was isolated from the riser (109) and the pressure was manually exhausted to trigger the supervisory switch (113) to switch. This, however, requires that maintenance personnel be onsite to perform the maintenance which was costly and time intensive. Further, in manual isolation, it was extremely difficult, if not impossible, to determine if the switch (113) could detect over pressurization without purposefully attaching something to over pressurize the piping (121) which could be undesirable.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, are systems and methods for the remote testing of a pressure switch, particularly a supervisory switch in a fire sprinkler system. Generally these systems and methods test for two elements of correct sensing and switching. The first is that a decrease in pressure below a target low threshold is detected. The second is that a change in pressure above the low pressure threshold, indicative of the pressure exceeding a high threshold, is also detected. In normal operation, the low and high threshold are generally spaced on either side of the expected or target pressure which would normally be maintained in the system. In the systems and methods discussed herein, these thresholds may be moved to allow for testing.

There is described herein, among other things, a method for testing activation of a supervisory switch in a dry pipe fire sprinkler system, the method comprising: providing in a dry pipe fire sprinkler system, a supervisory switch for determining deviation of fluid pressure in piping from a supervisory pressure, the piping being in fluid communication with a riser at a first end of the piping via a first valve, which is open, upstream of the supervisory switch and between the riser and the supervisory switch; providing a second valve, which is closed, downstream of the supervisory switch and between the supervisory switch and an orifice at a second end of the piping; allowing pressure in the piping and the riser to equalize at a pressure between an original low pressure threshold and an original high pressure threshold; closing the first valve to isolate fluid in the piping; after the piping is isolated, opening the second valve to exhaust fluid in the piping out the orifice; monitoring the exhausting of the fluid; detecting at a location remote from the dry pipe fire sprinkler system, the supervisory switch activating during the monitoring; and determining if the activating occurred at a fluid pressure in the piping corresponding to the original low pressure threshold.

In an embodiment of the method, the first valve and the second valve are solenoid valves.

In an embodiment of the method, the supervisory switch is a digital device.

In an embodiment of the method, the original low pressure threshold and the original high pressure threshold are programmed into the supervisory switch.

In an embodiment of the method, the original low pressure threshold is altered during the testing.

In an embodiment of the method, after the detecting, the second valve is closed newly isolating fluid in the piping, the newly isolated fluid being at a pressure below the original low pressure threshold.

In an embodiment of the method, while the newly isolating fluid is at a pressure below the original low pressure threshold, altering the original high pressure threshold to a modified high pressure threshold below the original high pressure threshold.

In an embodiment, the method further comprises: opening the first valve to allow fluid to flow from the riser into the piping to increase pressure in the piping; detecting at a location remote from the dry pipe fire sprinkler system, the supervisory switch activating during the opening; and determining if the activating during the opening occurred at a fluid pressure in the piping corresponding to the modified high pressure threshold.

In an embodiment, the method further comprises: allowing the pressure in the piping and the riser to again equalize at a pressure above the modified high pressure threshold.

In an embodiment, the method further comprises: returning the modified high pressure threshold to the original high pressure threshold.

In an embodiment of the method, the modified high pressure threshold is below the supervisory pressure.

In an embodiment of the method, the modified high pressure threshold is a first amount below the original high pressure threshold.

In an embodiment, the method further comprises: altering the original low pressure threshold to a modified low pressure threshold which is the first amount below the original low pressure threshold.

In an embodiment of the method, the modified low pressure threshold is below the pressure of the newly isolated fluid.

There is also described herein, in an embodiment, a system for testing activation of a supervisory switch in a dry pipe fire sprinkler system, the method comprising: a supervisory switch for determining deviation of fluid pressure in piping from a supervisory pressure, the piping being in fluid communication with a riser at a first end of the piping via a first solenoid valve, which is open, upstream of the supervisory switch and between the riser and the supervisory switch; a second solenoid valve, which is closed, downstream of the supervisory switch and between the supervisory switch and an orifice at a second end of the piping; and a controller in communication with the supervisory switch, the first solenoid valve and the second solenoid valve; wherein, the controller closes the first solenoid valve to isolate fluid in the piping; wherein, after the fluid in the piping is isolated, the controller opens the second valve to exhaust fluid in the piping out the orifice; wherein, the supervisory switch activates during the monitoring because fluid pressure in the piping drops below an original low pressure threshold; and wherein, the controller remotely detects the supervisory switch activation.

In an embodiment of the system, after the controller detects the supervisory switch activation, the controller closes the second valve newly isolating fluid in the piping, the newly isolated fluid being at a pressure below the original low pressure threshold.

In an embodiment of the system, while the newly isolated fluid is at a pressure below the original low pressure threshold, the controller alters the original high pressure threshold to a modified high pressure threshold below the supervisory pressure.

In an embodiment of the system, the controller: opens the first valve to allow fluid to flow from the riser into the piping to increase pressure in the piping; and detects at a location remote from the dry pipe fire sprinkler system, the supervisory switch activating at a fluid pressure in the piping corresponding to the modified high pressure threshold.

In an embodiment of the system, the modified high pressure threshold is a first amount below the original high pressure threshold.

In an embodiment of the system, the controller alters the original low pressure threshold to a modified low pressure threshold which is the first amount below the original low pressure threshold.

### BRIEF DESCRIPTION OF THE DRAWINGS

FIG. 1 is a general block diagram of a dry pipe sprinkler system valve arrangement.

### DESCRIPTION OF PREFERRED EMBODIMENT(S)

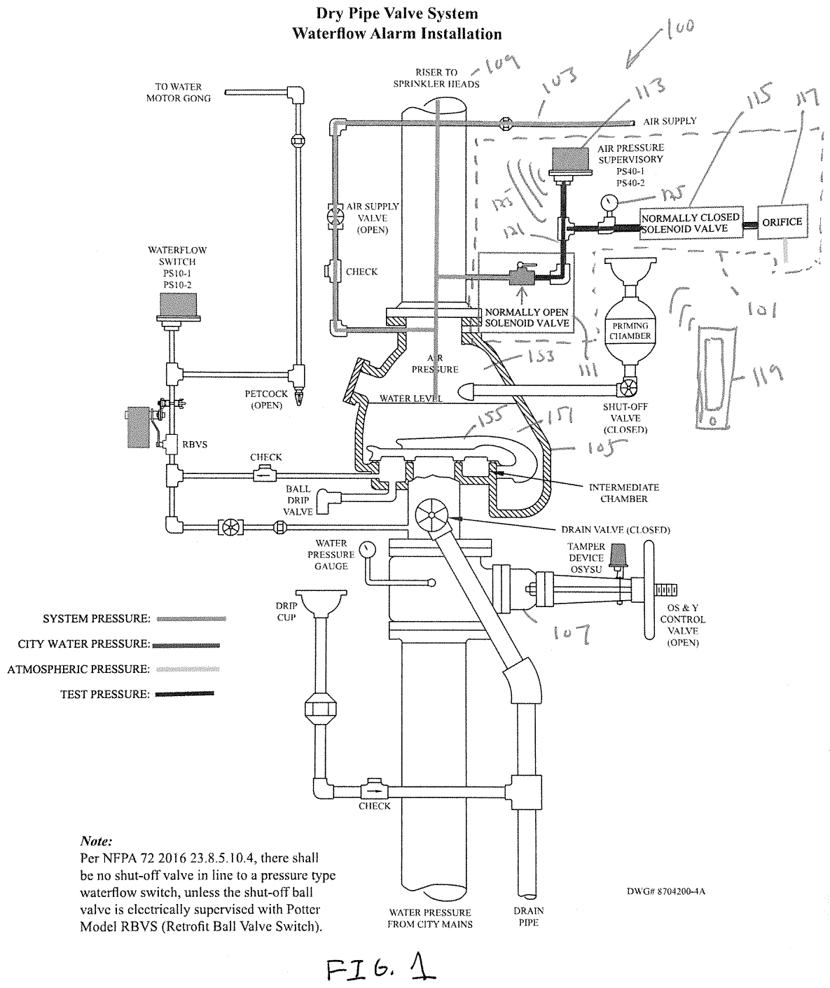

As indicated above, FIG. 1 provides for a general overview of a dry pipe sprinkler system (100) of the type known to those in the art. Elements of the municipal water source (107), valve chamber (105), air supply subsystem (103), and riser (109) with attached piping and sprinkler heads are typically of the conventional type known to those of ordinary skill in the art. The present disclosure is instead focused on the elements of the pressure monitoring subsystem (101). Traditionally, the pressure monitoring subsystem (101) included the air pressure supervisory switch (113) as well as manual valves to isolate the switch (113).

In the depicted embodiment of FIG. 1, the pressure monitoring subsystem (101) comprises the air pressure supervisory switch (113), a first solenoid valve (111), a second solenoid valve (115) and an exhaust port or orifice (117). There is also piping (121) interconnecting all the components and an optional pressure sensor (125). Further, connected to the various elements of the pressure monitoring subsystem (101) by a wired or wireless connection (123), there is a controller (119).

In an alternative embodiment, the pressure monitoring subsystem (101) may include the air pressure supervisory switch (113) and exhaust port (117), but the first solenoid valve (111) and second solenoid valve (115) may be replaced with a single three-way valve. In such an embodiment, this three-way valve will typically be positioned in around the same position as the first solenoid valve (111).

The controller (119) may be any form of computer or other digital processor. Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wrist-wear, pendants, and clip-on devices.

In many cases the “computer” discussed herein will be designed to be mobile and may be referred to as a “mobile communication device.” For purposes of this disclosure, there will also be significant discussion of a special type of com or simply “mobile device”. A mobile communication device may be, but is not limited to, a smart phone, tablet PC, e-reader, satellite navigation system (“SatNav”), fitness device (e.g. a Fitbit™ or Jawbone™) or any other type of mobile computer, whether of general or specific purpose functionality. Generally speaking, a mobile communication device is network-enabled and communicating with a server system providing services over a telecommunication or other infrastructure network. A mobile communication device is essentially a mobile computer, but one which is commonly not associated with any particular location, is also commonly carried on a user's person, and usually is in near-constant real-time communication with a network.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth™ and other wireless communication devices, virtual memory, storage devices and associated controllers, firmware, serial communications, and device drivers. The systems and methods described herein are contemplated to use computers and computer software typically stored in a computer- or machine-readable storage medium or memory.

Throughout this disclosure, terms used herein to describe or reference media-holding software, including without limitation terms such as “media,” “storage media,” and “memory,” may include or exclude transitory media such as signals and carrier waves.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

In the depicted embodiment of FIG. 1, the controller (119) is depicted as a “smartphone” which would utilize a software application (“app”) for controlling the system (100). While this can be useful in some embodiments, then controller (119) will often be software, firmware, or hardware functionality which is present in a fire alarm control panel associated with the sprinkler system (100). These are typically present with sprinkler systems (100) to provide for general control and monitoring of the system (100) as well as other desired functionality including the ability to test the system and the like. A fire alarm control panel can be connected to the other components of the system (100) by wired connections, wireless connections, or a combination of both. Even if the controller (119) is not a part of the fire alarm control panel, the controller (119) may interface with a fire alarm control panel to provide the control panel with information from the controller (119) or to allow the controller (119) to control the various elements of the pressure monitoring subsystem (101) via the fire alarm control panel.

The air pressure supervisory switch (113) will typically be a digital device and will be in communication with the controller (119) such as via a network. The controller (119) will typically provide the supervisory switch (113) with the low and high pressure thresholds that will be used by the pressure supervisory switch (113). These may be held internally in memory in the supervisory switch (113) after they are provided. The controller (119) will also typically serve to initiate and control the testing activity of the pressure monitoring subsystem (101).

As a digital device, the supervisory switch (113) will typically include as part of software or firmware the low and high pressure threshold provided by the controller. As opposed to being fixed amounts set in hardware, by providing the thresholds via software the supervisory switch (113) is programmable and, therefore, can be used in a variety of different environments where the target pressure as well as low and high pressure thresholds may be different. It also allows for automated and remote testing as contemplated below.

The first (111) and second (115) solenoid valves will comprise electrically actuated valves which are also typically under the control of the controller (119). These will be positioned so as to place the first solenoid valve (111) upstream between the riser (109) and the supervisory switch (113) and the second solenoid valve (115) will be on the downstream side of the supervisory switch (113). The solenoid valves (111) and (115) will serve to open and close the internal volume of the piping (121) to allow or disallow fluid transfer through themselves. After and downstream of the second solenoid valve (115), there will be an orifice (117) which allows for gas communication between the interior of the piping (121) and the ambient environment. During normal operation of the system (100), the first solenoid valve (111) will typically be open to allow for gas pressure in the riser (109) and the piping (121) at the supervisory switch (113) to equalize. The second solenoid valve (115) will typically be closed to inhibit gas from escaping from the riser (109) out the orifice (117).

In order to test the system, the controller (119) will typically initialize a number of actions which may be performed remotely, automatically, and in real-time or near real-time. In an example, maintenance personnel will use a smart phone application (“app”) as the controller (119) communicating via a network such as the Internet with the solenoid valves (111) and (115) and the supervisory switch (113) to initiate testing.

At the start of the test, the controller (119) will prepare for a test and get ready to record the outcome. At this time, the supervisory switch (113) is set to its normal high and low pressure thresholds and the riser (109) would be at or around the expected supervisory (normal) pressure. During a test, the supervisory switch (113) will generally be unable to detect an actual loss of pressure in the riser (109). Thus, other mechanisms may be activated or activities performed to insure that should the system (100) trigger from a fire during the testing, that is detected.

Once the system (100) is otherwise prepared for testing, the first solenoid valve (111) will be closed by the controller (119). This will serve to isolate the supervisory switch (113) from the riser (109) and the outside ambient. After the first solenoid valve (111) is closed, the second solenoid valve (115) will be opened. This will allow gas pressure in the piping (121) to escape via the orifice (117) which will reduce the pressure in the piping (121). As the piping (121) has been isolated from the riser (109), this escape will not serve to decrease the pressure in the riser (109).

As the gas pressure in the piping (121) decreases, the supervisory switch (113) should react to that decreasing pressure once the decrease passes the set low threshold. The actual pressure in the piping (121) may be detected by a sensor (125) which may be monitored by the controller (119) in an embodiment. As the controller (119) knows the threshold at which the supervisory switch (113) should switch to indicate low pressure, the controller (119) may compare the pressure at the sensor (125) and determine if the supervisory switch (113) does indeed trigger at the correct pressure as indicated by sensor (125). Should these match, the supervisory switch (113) has passed the test. Should they not, an error condition may be indicated.

Alternatively to including a pressure sensor (125), the amount of time it takes for the supervisory switch (113) to trigger after the second solenoid valve (115) is opened may be monitored by the controller (119). As the leak rate of the orifice (119) can be known (based on how open the second solenoid valve (115) switch is and the size of orifice (119)) the amount of time it takes for the supervisory switch (113) to indicate low pressure is directly proportional to the pressure at which the supervisory switch (113) triggered and, thus, a correct time to trigger corresponds to triggering at the target low threshold.

Testing for over pressurization has typically not been possible as it was very difficult to place the piping (121) at a pressure above the riser (109) without introducing additional pressure via the orifice (117) which is typically difficult without a technician being present and can be undesirable. The present system, however, may test the supervisory switch (113) for activation at the high pressure threshold by adjusting the high pressure threshold and looking for correct relative activation of the supervisory switch (113) at the modified high pressure threshold compared to the low pressure activation threshold.

Testing for over pressurization will typically occur during repressurization of the piping (121) after triggering at the low pressure threshold has occurred. Once testing for the low pressure threshold has been completed, the second solenoid valve (115) will be closed. This results in the supervisory switch (113) again being completely isolated from the riser (109) and ambient. At this time, the piping (121) is at a pressure below the low pressure threshold of the supervisory switch (113). While the supervisory switch (113) is so isolated, the controller (119) will serve to alter the high pressure threshold of the supervisory switch to a target pressure which is below the normal supervisory (or expected) pressure in the riser (109). It may even be at or below the original low pressure threshold.

To give an example of how this works. Typical supervisory pressure, or the pressure at which the riser (109) is normally maintained may be 45 PSI. In this situation, the low pressure threshold of the supervisory switch (113) may typically be around 35 PSI while the high threshold may be around 55 PSI. When the gas pressure was bled off via the orifice (117), the pressure in the piping (121) would typically drop to below 35 PSI as this would typically be used to test the supervisory switch's (113) triggering of a low pressure warning.

It should be apparent that it is typically not possible to increase the pressure in the piping (121) to above 45 PSI using just gas in the riser (109) unless the riser (109) was actually over pressure which is highly undesirable and difficult to perform in a testing situation. Thus, while the piping (121) is below the low pressure threshold (35 PSI in this example), the controller (119) will instead set the high threshold at the supervisory switch (113) to a lower value. This value will typically be between the original low pressure threshold and the original high pressure threshold but, in an embodiment, may be at or below the original low pressure threshold. In an embodiment, adjustment may be done solely by adjusting the high pressure threshold. For example, the high pressure threshold may be set to 40 PSI while the low pressure threshold remains at 35 PSI. In an alternative embodiment, the adjustment may be performed by moving both the low and high pressure threshold as a fixed window. The latter option will be discussed in detail below.

In an embodiment, the pressure in the piping (121) will be allowed to drop to a value that will be below a new target low pressure threshold of the moved window. In this example, the pressure in the piping (121) is allowed to drop to below 20 PSI. The window of the high and low threshold is then shifted down 15 PSI. Thus, the original low threshold of 35 PSI becomes 20 PSI and the high threshold of 55 PSI becomes 40 PSI. It should be recognized that the difference in PSI between the original high and low threshold can be valuable to maintain.

In this example, as the pressure in the piping (121) is below the new low threshold (and static since both solenoid valves (111) and (115) are closed), the supervisory switch (113) should still be indicating a low pressure condition. The first solenoid valve (111) will now be opened and pressure in the piping (121) will be allowed to equalize with the pressure in the riser (109). As the volume of the piping (121) is typically very small compared to the volume of the riser (109) and the rest of the system (100), pressure equalization of the piping (121) will typically not cause any substantial change in the pressure of the system (100).

As the pressure in the piping (121) increases, the supervisory switch (113) will eventually no longer detect a low pressure situation as the pressure in the piping (121) passes the low pressure threshold (which may be the new threshold as indicated above). When the supervisory switch (113) ceases indicating the low pressure situation, the time it takes for the supervisory switch (113) to indicate a high pressure situation may be monitored. The actual pressure in the piping (121) may also or alternatively be monitored using sensor (125). In the first situation, the time it takes should correspond to the difference between the modified low pressure threshold and the modified high pressure threshold. As discussed, this may be the same difference as before (with both values having been moved) or a smaller value (if only the high pressure threshold is moved).

As the high pressure threshold is now below the expected pressure in the riser (109), the supervisory switch (113) should indicate a high pressure situation before the pressure in the piping (121) actually equalizes with the pressure in the riser (109). Should the trigger of the supervisory switch occur correctly, either because it occurs at the correct pressure as indicated by sensor (125) or at the correct difference in time or pressure from the low pressure indication having ceased, the supervisory switch (113) has passed the test. Otherwise an error situation may be indicated.

Once this test has completed, the controller (119) will serve to return the threshold values of the supervisory switch (113) to their original values. It should be apparent that once the original values have been restored, the supervisory switch (113) should cease any warning situation as the piping (121) will typically have returned to a value at or close to the supervisory pressure in the riser (109) which is between the original, and now current, low and high threshold.

The qualifier “generally” and similar qualifiers, as used in the present case, would be understood by one of ordinary skill in the art to accommodate recognizable attempts to conform a device to the qualified term, which may nevertheless fall short of doing so. This is because terms such as “sphere” are purely geometric constructs and no real-world component is a true “sphere” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally,” and relationships contemplated herein regardless of the inclusion of such qualifiers, to include a range of variations from the literal geometric meaning of the term in view of these and other considerations.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A method for testing activation of a supervisory switch in a dry pipe fire sprinkler system, the method comprising:
providing in a dry pipe fire sprinkler system, a supervisory switch for determining deviation of fluid pressure in piping from a supervisory pressure, said piping being in fluid communication with a riser at a first end of said piping via a first valve, which is open, upstream of said supervisory switch and between said riser and said supervisory switch;
providing a second valve, which is closed, downstream of said supervisory switch and between said supervisory switch and an orifice at a second end of said piping;
allowing pressure in said piping and said riser to equalize at a pressure between an original low pressure threshold and an original high pressure threshold;
closing said first valve to isolate fluid in said piping;
after said piping is isolated, opening said second valve to exhaust fluid in said piping out said orifice;
monitoring said exhausting of said fluid;
detecting at a location remote from said dry pipe fire sprinkler system, said supervisory switch activating during said monitoring; and
determining if said activating occurred at a fluid pressure in said piping corresponding to said original low pressure threshold.

2. The method of claim 1 wherein said first valve and said second valve are solenoid valves.

3. The method of claim 1 wherein said supervisory switch is a digital device.

4. The method of claim 3 wherein said original low pressure threshold and said original high pressure threshold are programmed into said supervisory switch.

5. The method of claim 4 wherein said original low pressure threshold is altered during said testing.

6. The method of claim 3 wherein after said detecting, said second valve is closed newly isolating fluid in said piping, said newly isolated fluid being at a pressure below said original low pressure threshold.

7. The method of claim 6 wherein while said newly isolating fluid is at a pressure below said original low pressure threshold, altering said original high pressure threshold to a modified high pressure threshold below said original high pressure threshold.

8. The method of claim 7 further comprising:
opening said first valve to allow fluid to flow from said riser into said piping to increase pressure in said piping;
detecting at a location remote from said dry pipe fire sprinkler system, said supervisory switch activating during said opening; and
determining if said activating during said opening occurred at a fluid pressure in said piping corresponding to said modified high pressure threshold.

9. The method of claim 8 further comprising:
allowing said pressure in said piping and said riser to again equalize at a pressure above said modified high pressure threshold.

10. The method of claim 9 further comprising:
returning said modified high pressure threshold to said original high pressure threshold.

11. The method of claim 7 wherein said modified high pressure threshold is below said supervisory pressure.

12. The method of claim 7 wherein said modified high pressure threshold is a first amount below said original high pressure threshold.

13. The method of claim 12 further comprising: altering said original low pressure threshold to a modified low pressure threshold which is said first amount below said original low pressure threshold.

14. The method of claim 13 wherein said modified low pressure threshold is below said pressure of said newly isolated fluid.

15. A system for testing activation of a supervisory switch in a dry pipe fire sprinkler system, the method comprising:
a supervisory switch for determining deviation of fluid pressure in piping from a supervisory pressure, said piping being in fluid communication with a riser at a first end of said piping via a first solenoid valve, which is open, upstream of said supervisory switch and between said riser and said supervisory switch;
a second solenoid valve, which is closed, downstream of said supervisory switch and between said supervisory switch and an orifice at a second end of said piping; and
a controller in communication with said supervisory switch, said first solenoid valve and said second solenoid valve;
wherein, said controller closes said first solenoid valve to isolate fluid in said piping;
wherein, after said fluid in said piping is isolated, said controller opens said second valve to exhaust fluid in said piping out said orifice;
wherein, said supervisory switch activates during said monitoring because fluid pressure in said piping drops below an original low pressure threshold; and
wherein, said controller remotely detects said supervisory switch activation.

16. The system of claim 15 wherein after said controller detects said supervisory switch activation, said controller closes said second valve newly isolating fluid in said piping, said newly isolated fluid being at a pressure below said original low pressure threshold.

17. The system of claim 16 wherein while said newly isolated fluid is at a pressure below said original low pressure threshold, said controller alters said original high pressure threshold to a modified high pressure threshold below said supervisory pressure.

18. The system of claim 17 wherein said controller:
opens said first valve to allow fluid to flow from said riser into said piping to increase pressure in said piping; and
detects at a location remote from said dry pipe fire sprinkler system, said supervisory switch activating at a fluid pressure in said piping corresponding to said modified high pressure threshold.

19. The system of claim 18 wherein said modified high pressure threshold is a first amount below said original high pressure threshold.

20. The system of claim 19 wherein said controller alters said original low pressure threshold to a modified low pressure threshold which is said first amount below said original low pressure threshold.
